(19) United States
(12) Patent Application Publication
(10) Pub. No.: US 2026/0154776 A1
(43) Pub. Date: Jun. 4, 2026

(54) SYSTEMS AND METHODS FOR DETECTING ERRORS IN FRAME DATA USING ARTIFICIAL INTELLIGENCE

(71) Applicant: Samsung Electronics Co., Ltd., Suwon-si (KR)

(72) Inventor: Xiao Sun, Austin, TX (US)

(21) Appl. No.: 19/231,406

(22) Filed: Jun. 6, 2025

Related U.S. Application Data
(60) Provisional application No. 63/727,536, filed on Dec. 3, 2024.

(51) Int. Cl. G06T 1/20; G06N 20/00

(52) U.S. Cl. CPC G06T 1/20; G06N 20/00

(57) ABSTRACT

A system and a method are disclosed for detecting errors in frame data. The method including receiving, by a graphics processing circuit, sensor data, generating, by the graphics processing circuit, first frame data based on the sensor data, receiving, by a machine-learning model of an inferencing circuit, second frame data generated based on the first frame data, generating, by the machine-learning model, recognition data associated with the second frame data, detecting, by a checking circuit, a difference between the sensor data and the recognition data, and sending, by the checking circuit, an error signal.

### CROSS-REFERENCE TO RELATED APPLICATION

This application claims the priority benefit under 35 U.S.C. § 119(e) of U.S. Provisional Application No. 63/727,536, filed on Dec. 3, 2024, the disclosure of which is incorporated by reference in its entirety as if fully set forth herein.

### TECHNICAL FIELD

The disclosure generally relates to systems and methods for error detection. More particularly, the subject matter disclosed herein relates to improvements to systems and methods for detecting errors in frame data used for machine operations.

### SUMMARY

There is a demand for graphics processing units (GPUs) (e.g., graphics processing circuits) to render functional safety-related objects (e.g., 3-dimensional (3D) functional safety objects). For example, such GPUs may be used in automotive in-vehicle infotainment (IVI) systems or robotic systems. Such a GPU may be included as a component of a system-on-a-chip (SOC also referred to as SoC). In such IVI systems, GPU-rendered functional safety-related objects may be used to replace and/or to improve the visual experience of conventional dials (e.g., mechanical dials) used to display functional safety-critical information such as a speed of car, a revolutions-per-minute (RPM) reading, a direction of the car, or surrounding cars passing by. However, it may be challenging to make a GPU (e.g., a 3D GPU) that meets functional safety levels that meet standards (e.g., a standardized automotive safety level, such as ISO 26262 auto safety integrity level (ASIL) B or ASIL D). Malfunctions in displaying functional safety-critical information can cause non-serious and serious human bodily injuries with life-threatening consequences. Malfunctions can result from complex GPU hardware (HW) architectures in parallel with complex software (SW) collaterals.

For example, making a GPU HW compliant with ASIL B may be challenging because it can take at least 30% of an area overhead to make GPU HW that reaches ASIL B metrics, such as a single-point failure metric (SPFM) >90% and a latent fault metric (LFM) >60%. The SPFM may also refer to a single permanent fault (or failure) coverage being greater than 90%. For example, single permanent fault coverage may be used to distinguish SPFM from a soft fault. Making a GPU HW compliant with ASIL B can cause lower performance and higher power drain during frame gaps. Making a GPU HW compliant with ASIL B may require spatial isolation to achieve the safety ASIL B goals. For example, two hardware shaders (e.g., two shader slices) may take turns to be tested via online built-in self-test (BIST) with two independent GPU front ends in a system that is capable of resetting either of the GPU front ends if a permanent fault occurs for freedom from interference (FFI).

GPU SW may also have challenges in meeting standards (e.g., ASIL B). For example, a GPU shader compiler may generate indeterministic results, which may prevent checking (e.g., deterministically checking) expected results from a known workload. For example, some methods (e.g., software test libraries (STL)) may not allow for successful testing of HW and SW. For example, safe application programming interface (API) experts estimate that it may take 3 to 5 years to certify GPU-SW collaterals to meet HW and SW standards (e.g., ASIL B standards).

Aspects of embodiments of the present disclosure provide for improved systems and methods for detecting errors in frame data, such that the systems may be capable of meeting standards (e.g., standards that present the challenges discussed above with respect to ASIL B and ASIL D). For example, in some embodiments, a hardware acceleration block (e.g., a neural processing unit (NPU), DSP, or inference hardware accelerator) may be used to perform inferencing tasks, such as object recognition. In some embodiments, a CPU (e.g., an ASIL B CPU or an ASIL D CPU) may be used to compare safety results. Aspects of some embodiments of the present disclosure may allow for systems (e.g., systems using a CPU and an NPU) to meet ASIL B SOC.

In some embodiments, the system may include NPU/CPU in ASIL B (or in ASIL D) as an end-to-end ASIL checker to check whether GPU rendered safety cluster display frames are correct according to GPU inputs. In some embodiments, the GPU inputs may include safety workloads, including workloads for showing a gauge or meter (e.g., a dial), for showing cars passing by a car, for showing pedestrians around the car, or for showing car orientation (e.g., GPS direction orientation). In some embodiments, the icons of 3D objects may be pre-determined but may be rendered differently in 2D display through the GPU.

In some embodiments, an inferencing circuit (e.g., an ASIL B NPU) may have two input sources: (1) trained models and coefficients used for inference work and (2) GPU output frames/safety contents (e.g., frame data including a representation of a safety-related object). In some embodiments, the GPU output frames are processed through an inferencing engine (e.g., with the inferencing circuit) and then the GPU may send an output (e.g., inference results/recognition data) to a CPU (e.g., an ASIL B CPU or an ASIL D CPU). The CPU may be made aware of safety rendering objects and intents, based on GPU API calls. The CPU may check whether the inference results from the NPU meet the GPU input intents (e.g., whether the inference results match the intended GPU inputs). If yes, then the GPU may pass the ASIL B checker based on a determination that it is functioning properly for safety critical mission mode. If, on the other hand, the inference results from the NPU fail to meet the GPU input intents, then the CPU may report the error to a fault handling circuit (e.g., an SOC fault handling module) and may generate an interrupt to reset the GPU. The CPU may then report to an external micro controller unit (MCU) (e.g., an ASIL B MCU or an ASIL D MCU) so that the external MCU can take any further appropriate actions to address the error.

In some embodiments, an NPU may be capable of detecting objects (e.g., real-life objects) at about 90% accuracy and up to 100% accuracy with pre-determined objects. In some embodiments, 3D objects may be pre-determined so that the training model used for NPU interfering can be 100% accurate. In some embodiments, pre-determined objects and new trained models may be upgraded and/or changed via transmitted updates (e.g., over-the-air updates). In some embodiments, a checking circuit (e.g., a CPU checker) can be 100% accurate as the checking circuit may be aware of GPU safety display work. For example, in some embodiments, the checking circuit is made aware of GPU safety display work by hardware connection. In some embodiments, the interference and checking work may achieve (e.g., can easily achieve) ASIL B metrics (or ASIL D metrics), such as an SPFM >90% and an LFM >60%.

The above approaches may improve on previous methods because safety performance standards for GPUs may be satisfied with less area overhead and lower power usage. For example, aspects of some embodiments may provide for a high performance ASIL B GPU or ASIL D GPU with reduced (e.g., with no) performance power degradation from STL or BIST testing. In some embodiments, checking circuits may include multiple instances (for example multiple CPUs), a GPU may include multiple instances, and an inferencing circuit may include multiple instances (for example, multiple NPUs).

According to some embodiments of the present disclosure, a method for detecting errors in frame data includes receiving, by a graphics processing circuit, sensor data, generating, by the graphics processing circuit, first frame data based on the sensor data, receiving, by a machine-learning model of an inferencing circuit, second frame data generated based on the first frame data, generating, by the machine-learning model, recognition data associated with the second frame data, detecting, by a checking circuit, a difference between the sensor data and the recognition data, and sending, by the checking circuit, an error signal.

The detecting the difference between the sensor data and the recognition data may include determining that an object is erroneously represented in the first frame data.

The inferencing circuit may include a neural processing unit (NPU), the checking circuit may include a central processing unit (CPU), and the NPU and the CPU may comply with a standardized automotive safety level.

At least one of the graphics processing circuit, the inferencing circuit, or the checking circuit may include multiple instances.

The method may further include receiving, by a fault handling circuit, the error signal, generating, by the fault handling circuit, an interrupt to reset the graphics processing circuit, and sending, by the fault handling circuit, a report to a microcontroller.

The method may further include training the machine-learning model offline based on training frame data generated by a training graphics processing circuit, the training may include receiving, by a first training machine-learning model, the training frame data, receiving, by a second training machine-learning model, the training frame data, and determining that a first output of the first training machine-learning model matches a second output of the second training machine-learning model.

The method may further include receiving an update to the machine-learning model, generating an updated machine-learning model based on the update, and training the updated machine-learning model online.

The receiving of the update to the machine-learning model may be performed wirelessly.

The sensor data may be associated with operating a vehicle or operating a robot.

According to other embodiments of the present disclosure, a system for detecting errors in frame data includes a graphics processing circuit configured to receive sensor data and generate first frame data based on the sensor data, an inferencing circuit including a machine-learning model configured to receive second frame data generated based on the first frame data, and generate recognition data associated with the second frame data, and a checking circuit configured to detect a difference between the sensor data and the recognition data, and send an error signal.

The detecting the difference between the sensor data and the recognition data may include determining that an object is erroneously represented in the first frame data.

The inferencing circuit may include a neural processing unit (NPU), the checking circuit may include a central processing unit (CPU), and the NPU and the CPU may comply with a standardized automotive safety level.

The system may further include a compression circuit configured to compress the first frame data to generate the second frame data.

The system may include a fault handling circuit configured to perform receiving the error signal, generating an interrupt to reset the graphics processing circuit, and sending a report to a microcontroller.

The machine-learning model may be trained offline based on training frame data generated by a training graphics processing circuit, the training may include receiving, by a first training machine-learning model, the training frame data, receiving, by a second training machine-learning model, the training frame data, and determining that a first output of the first training machine-learning model matches a second output of the second training machine-learning model.

The system may be configured to perform receiving an update to the machine-learning model, generating an updated machine-learning model based on the update, and training the updated machine-learning model online.

The receiving of the update to the machine-learning model may be performed wirelessly.

According to other embodiments of the present disclosure, a system for detecting errors in frame data includes a processing circuit, and a memory communicatively coupled to the processing circuit and storing instructions that, based on being executed by the processing circuit, cause the processing circuit to receive sensor data, receive recognition data from an inferencing circuit, the recognition data being generated based on first frame data from a graphics processing circuit, detect a difference between the sensor data and the recognition data, and send an error signal.

The detecting the difference between the sensor data and the recognition data may include determining that an object is erroneously represented in the first frame data.

The system may be a vehicle or a robot.

### BRIEF DESCRIPTION OF THE DRAWING

In the following section, the aspects of the subject matter disclosed herein will be described with reference to exemplary embodiments illustrated in the figures.

FIG. 1 is a block diagram depicting a system for detecting errors in frame data using artificial intelligence (AI), according to some embodiments of the present disclosure.

FIG. 2 is a block diagram depicting an offline training flow for the system of FIG. 1, according to some embodiments of the present disclosure.

FIG. 3 is a block diagram depicting an online updating and training flow for the system of FIG. 1, according to some embodiments of the present disclosure.

FIG. 4 is a flowchart depicting example operations of a method for detecting errors in frame data using AI, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), SoC, an assembly, and so forth.

Each of the terms “processing circuit” and “means for processing” is used herein to mean any suitable combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As discussed above, there is a demand for GPUs to render functional safety-related objects (e.g., 3D functional safety objects). For example, such GPUs may be used in automotive IVI systems. Such a GPU may be included as a component of a SOC. In such IVI systems, GPU-rendered functional safety-related objects may be used to replace and/or to improve the visual experience of conventional dials (e.g., mechanical dials) used to display functional safety-critical information such as a speed of car, an RPM reading, a direction of the car, or surrounding cars passing by). However, it may be challenging to make a GPU (e.g., a 3D GPU) that meets functional safety levels that meet standards (e.g., ISO 26262 ASIL B or ASIL D). Malfunctions in displaying functional safety-critical information can cause non-serious and serious human bodily injuries with life-threatening consequences. Malfunctions can result from complex GPU HW architectures and complex SW collaterals.

For example, making a GPU HW compliant with ASIL B may be challenging because it can take at least 30% of an area overhead to make GPU HW that reaches ASIL B metrics, such as an SPFM >90% and an LFM >60%. Making a GPU HW compliant with ASIL B can cause lower performance and higher power drain during frame gaps. Making a GPU HW compliant with ASIL B may utilize spatial isolation to achieve the safety ASIL B goals. For example, two hardware shaders may take turns to be tested via online BIST with two independent GPU front ends in a system that is capable of resetting either of the GPU front ends if a permanent fault occurs for FFI.

GPU SW may also have challenges in meeting standards (e.g., ASIL B). For example, a GPU shader compiler may generate indeterministic results, which may prevent checking (e.g., deterministically checking) expected results from a known workload. For example, some methods (e.g., STL) may not allow for successful testing of HW and SW.

Aspects of embodiments of the present disclosure provide for improved systems and methods for detecting errors in frame data, such that the systems may be capable of meeting standards (e.g., standards that present the challenges discussed above for ASIL B and ASIL D). For example, in some embodiments, a hardware acceleration block (e.g., an NPU) may be used to perform inferencing tasks, such as object recognition. In some embodiments, a CPU (e.g., an ASIL B CPU or an ASIL D CPU) may be used to compare safety results. Aspects of some embodiments of the present disclosure may allow for systems (e.g., systems using a CPU and an NPU) to meet ASIL B for the SOC.

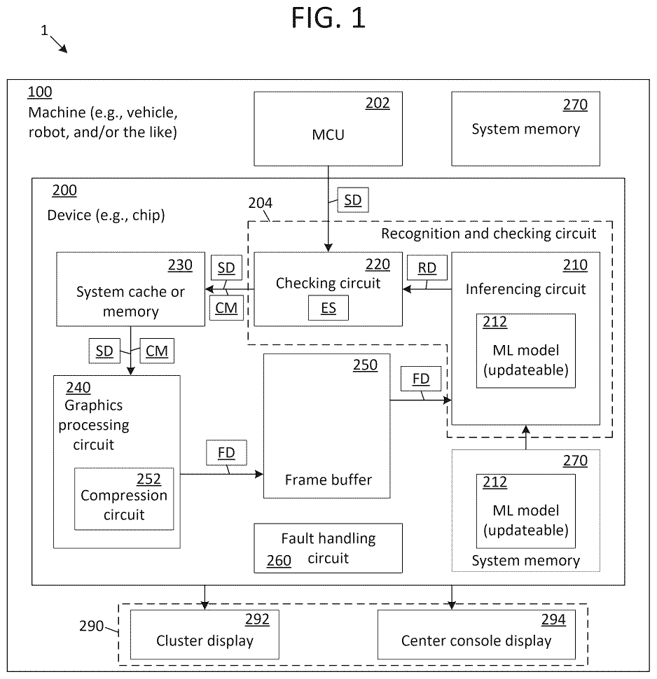

FIG. 1 is a block diagram depicting a system 1 for detecting errors in frame data FD using AI, according to some embodiments of the present disclosure.

Referring to FIG. 1, the system 1 for detecting errors in frame data FD may include a machine 100 (e.g., a vehicle, a robot, and/or the like). The machine 100 may include sensors for generating data (e.g., for generating safety-related data). The data may include sensor data SD generated by instruments, one or more output signals of one or more processing units of one or more cameras, radar, and/or the like. For example, the sensor data SD may be related to operating the machine 100 and may be related to images to be shown (e.g., to be displayed) via an electronic display 290. In some embodiments, the electronic display 290 may include a cluster display 292 and a center console display 294. The cluster display may display information (e.g., speed, RPMs, energy levels, and/or the like) to a user (e.g., to a driver or a person interacting with a robot). The center console display 294 may display images representing information captured via camera, radar, and/or the like to the user. In some embodiments, the sensor data SD from one or more sensors may be received by a micro controller unit (MCU) 202 (e.g., a micro-controller). The sensor data SD may be sent to a device 200 (e.g., an integrated circuit (IC) or SOC) for further processing to display the information on the electronic display 290 for the user and for checking for errors in the processed sensor data SD.

In some embodiments, the device 200 may include a graphics processing circuit (GPC) 240 (e.g., a graphics processing unit (GPU)) and a frame buffer 250 communicatively connected to the graphics processing circuit 240. As used herein, a “graphics processing circuit” refers to a device (e.g., a processing circuit or means for processing) that is capable of generating frames for display. In some embodiments, the graphics processing circuit 240 may include one or more instances (e.g., the graphics processing circuit 240 may be a processing circuit including one or more circuits). The graphics processing circuit 240 may include a compression circuit 252. An output of the frame buffer 250 may be communicatively connected to a recognition and checking circuit 204. The recognition and checking circuit 204 may include an inferencing circuit 210 (e.g., an NPU) for performing inferencing operations. For example, the inferencing circuit 210 may use AI to perform inferencing for object recognition.

In some embodiments, the inferencing circuit 210 may include one or more instances (e.g., the inferencing circuit 210 may be a processing circuit including one or more circuits, such as one or more NPUs). The inferencing circuit 210 may include a machine-learning (ML) model 212. The ML model 212 may be a trained model (e.g., a pretrained model). For example, the ML model 212 may be trained to perform an inference based on frame data FD generated by the graphics processing circuit 240. The inferencing circuit 210 may generate recognition data RD based on the frame data FD. For example, the recognition data RD may include data indicating recognized objects and/or orientations of objects from the frame data FD. As used herein, “frame data” refers to data associated with one or more frames (e.g., displayable frames) generated by a GPU (or a suitably similar device). For example, one frame may include information associated with one camera image or information associated with one or more vehicle gauges at the same moment in time. A displayable frame refers to a number of frames per second (e.g., a regular video speed can display 30 frames per second). As used herein, “recognition data” refers to data associated with an object identified within one or more frames of frame data. For example, recognition data may include information identifying one or more pre-determined objects (e.g., a dial, a nearby pedestrian, a nearby car, and/or the like).

In some embodiments, the ML model 212 may be updateable. In some embodiments, the ML model 212 may be stored in a system memory 270. For example, the system memory 270 may include non-volatile memory. The system memory may be on the device 200 and/or may be off the device 200 (e.g., on the machine 100). In some embodiments, the recognition and checking circuit 204 includes a checking circuit 220 (e.g., a CPU). In some embodiments, the checking circuit 220 may include one or more instances (e.g., the checking circuit 220 may be a processing circuit including one or more circuits). An output of the inferencing circuit 210 may be communicatively connected to the checking circuit 220. The checking circuit 220 may receive the sensor data SD from the MCU 202. The checking circuit 220 may detect errors in the frame data FD based on the sensor data SD and the recognition data RD.

The checking circuit 220 may send the sensor data SD and a list of commands CM (e.g., instructions for processing the sensor data SD) to the graphics processing circuit 240. In some embodiments, the checking circuit 220 may save (e.g., may store) the sensor data SD and the commands CM in a system cache or memory 230. For example, the system cache or memory 230 may be a shared memory that is cache coherent with the checking circuit 220, the graphics processing circuit 240, and/or the inferencing circuit 210. In some embodiments, the graphics processing circuit 240 may receive the sensor data SD and the commands CM from the system cache or memory 230.

In some embodiments, the graphics processing circuit 240 may generate frame data FD based on the sensor data SD and the commands CM. For example, the commands CM may inform (e.g., may instruct) the graphics processing circuit 240 on how to process the sensor data SD for displaying on the electronic display 290. In some embodiments, the frame buffer 250 may store the frame data FD before the first frame data FD is read by a display control unit and then displayed on the electronic display 290.

In some embodiments, the checking circuit 220 may include a CPU hardware unit giving the commands CM (e.g., GPU commands), receiving sensor data SD, and checking for errors based on NPU-recognized objects. In some embodiments, the checking circuit 220 may generate an error signal ES (e.g., an error-related signal) if the checking circuit 220 detects an error associated with the frame data FD. In some embodiments, the checking circuit 220 and the inferencing circuit 210 are components that comply with ASIL standards. For example, for the system 1 to comply with ASIL B, the checking circuit 220 may include an ASIL B CPU and the inferencing circuit 210 may include an ASIL B NPU. In other words, the NPU and the CPU may comply with a standardized automotive safety level (e.g., may comply with ASIL B). To comply with ASIL D, the checking circuit 220 may include an ASIL D CPU and the inferencing circuit 210 may include an ASIL D NPU. In other words, the NPU and the CPU may comply with a standardized automotive safety level (e.g., may comply with ASIL D). It should be understood that ASIL D has stricter standards than ASIL B, such that using an ASIL B CPU and an ASIL D NPU or using an ASIL D CPU and an ASIL B NPU would result in compliance with only ASIL B.

Still referring to FIG. 1, in some embodiments, the sensor data SD may originate externally from the device 200 through the MCU 202 (e.g., an external safety MCU). The sensor data SD may include any instrument data (e.g., safety critical instrument data) to be shown via safety cluster display dials and may include output signals of vision processing circuits and/or radar processing circuits for safety camera/radar to detect objects (e.g., cars or humans) around the device 200 (e.g., around the machine 100).

Some NPUs may be capable of detecting real life objects at about 90% accuracy, and up to 100% accuracy with pre-determined objects. In some embodiments, 3D objects may be pre-determined so that the training model used for NPU inferencing may be about 100% accurate. In some embodiments, the ML model 212 of the inferencing circuit 210 (e.g., of the NPU) may be upgraded/changed based on pre-determined objects and new trained models via over-the-air updates (e.g., via online updating and training). That is, in some embodiments, the ML model 212 may be updateable.

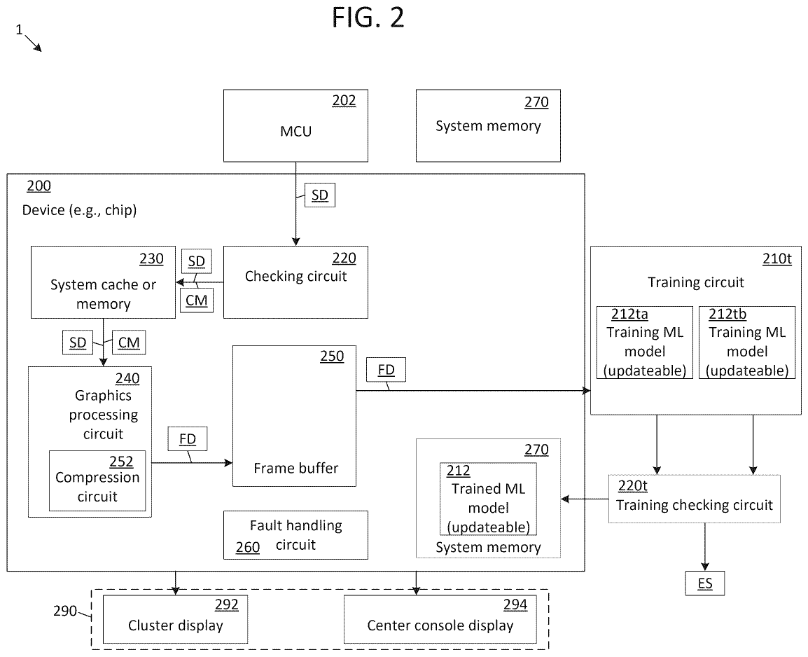

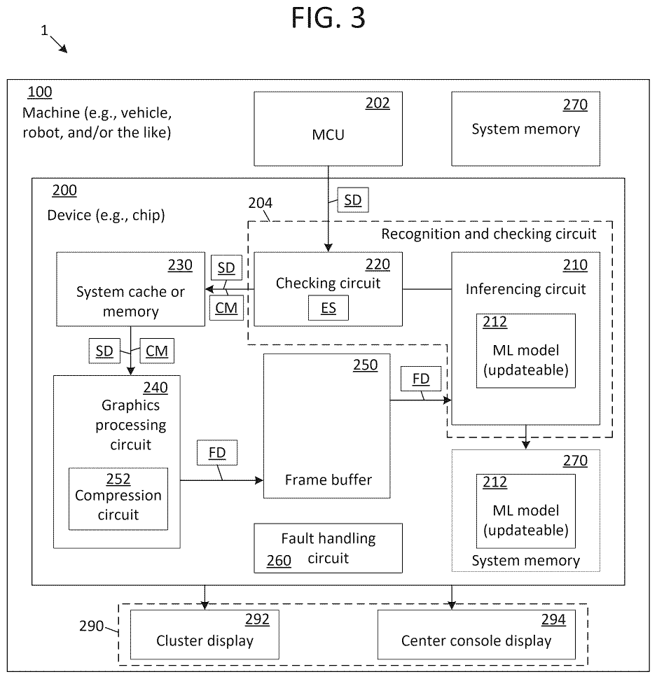

As discussed below with reference to FIGS. 2 and 3, because fixed types of 3D objects may be rendered by the graphics processing circuit 240 onto a 2D display in the device 200, in some embodiments, the same type of GPU HW/SW output (e.g., the same type of frame data FD) is used to train the ML model 212. For example, the same type of output of frame data FD may be used to train the ML model 212 off chip. In some embodiments, a training process may be conducted offline on off-chip high performance discrete GPU farms. In some embodiments, the training process may be conducted online on the inferencing circuit 210 (e.g., on the NPU) if the performance of the NPU is adequate for training purpose. In some embodiments, the ML model 212 may include a k-nearest neighbors (kNN) algorithm with a number of data points in a training data set (N)=1 to achieve, for example, about 100% accuracy. In some embodiments, the 3D objects rendered by the graphics processing circuit 240 (e.g., by the auto-safety GPU) and displayed is a predetermined and limited set. For example, the objects may include instrument dial needle positions associated with the actual sensor data. The limited set may be suitable for use with the NPU.

In some embodiments, a mission-mode checking flow includes an inference process from the inferencing circuit 210 taking frame data FD from the graphics processing circuit 240 and an end-to-end checking scheme to satisfy GPU ASIL (e.g., GPU ASIL B or GPU ASIL D), and may proceed as follows.

The ML model 212 is a pre-trained inferencing model that is trained from a given pre-determined object set (e.g., a given pre-determined 3D object set) and a list of sensor data SD (e.g., high-quality usable sensor data SD). In some embodiments, the checking circuit 220 and the graphics processing circuit 240 may include (e.g., may store) the same given pre-determined object set and the same list of sensor data SD. In some embodiments, the inferencing circuit 210 may know (e.g., may store) an area of the electronic display 290 (e.g., may know the safety display area) and a pixel size (e.g., coordinates) of the electronic display 290. In some embodiments, the graphics processing circuit 240 and the inferencing circuit 210 may cooperate to detect errors associated with safety-related information from the sensor data SD. It should be understood that some data received as sensor data may not be safety-related information. For example, color, light reflection and light from ray tracing and the texture on objects may not be considered to be safety-related information.

In some embodiments, the inferencing circuit 210 may use safety-related information and may use non-safety-related information to perform recognition of objects in the frame data FD and to generate recognition data RD. The checking circuit 220 may use the sensor data SD and the recognition data RD to detect errors. For example, the checking circuit 220 may check for missing objects, extra objects, or wrong objects in the frame data FD rendered by the graphics processing circuit 240. Examples of missing objects include a car passing by the surrounding area of the machine 100 but not being rendered, or a needle of a safety instrument dial (e.g., a speedometer, tachometer, and/or the like) not being shown. Examples of extra objects or wrong objects include a car that is not actually present being rendered, a nearby pedestrian being rendered as a car, a safety instrument dial being shown with the wrong number (e.g., indicating an erroneous measurement), a background picture of a dial (e.g., the dial itself) being incorrect, an extra needle of a safety instrument dial being shown, or an extra background picture (e.g., an extra dial image) being rendered. Examples of wrong objects may also include objects being displayed at the wrong location by the graphics processing circuit 240, such as a pedestrian or a car being displayed on the wrong side of the machine 100 and/or being displayed with the wrong distance (e.g., with the wrong coordinates). That is, the checking circuit 220 may identify differences between the sensor data SD and the recognition data RD to determine errors in the frame data FD generated by the graphics processing circuit 240. By cooperating with the ML model 212 of the inferencing circuit 210 for recognition tasks, the checking circuit 220 may detect errors in the frame data FD with high accuracy and high efficiency.

In some embodiments, mission-mode checking may be performed and finished in a frame gap. For example, a suitable fault detection time interval (FDTI) may be a rate of about 30 frames per second (FPS) with a 33.3 milli-second (ms) frame gap, for an automotive SOC with a fault tolerant time interval (FTTI) of 100-500 ms (depending on use cases) being greater than the sum of the FDTI and the fault reaction time interval (FRTI), which is equal to the fault handling time interval (FHTI) (e.g., FDTI+FRTI=FHTI<FTTI).

FIG. 2 is a block diagram depicting an offline training flow for the system of FIG. 1, according to some embodiments of the present disclosure.

Referring to FIG. 2, in some embodiments, an offline training of the ML model 212 may be conducted (e.g., before the device 200 is used in the field) for a given set of pre-determined 3D objects, for useful zoom levels, for useful view angles, for useful orientation variants, and for useful sensor data SD (e.g., for all useful sensor data). In some embodiments, a training flow from an output of the graphics processing circuit 240 to the inferencing circuit 210 (e.g., a training circuit 210t) may proceed as follows.

In some embodiments, the checking circuit 220 may generate possible (e.g., all possible) useful data for processing by the graphics processing circuit 240. For example, the useful data may include zoom data, view-angel data, orientation-variant data, and sensor data SD. The checking circuit 220 may form the useful data (e.g., one-by-one) as GPU API call commands for the graphics processing circuit 240 to render the objects (e.g., to render the pre-determined 3D objects). The checking circuit 220 may send the GPU API call commands to the graphics processing circuit 240. The graphics processing circuit 240 may render objects in the frame data FD (e.g., in first frame data) according to the received GPU API call commands. The graphics processing circuit 240 may send the rendered frame data FD to the frame buffer 250. The inferencing circuit 210 (e.g., the training circuit 210t) may receive the frame data FD (e.g., receives second frame data) one by one (e.g., one frame at a given time) to perform training of the ML model 212.

In some embodiments, the inferencing circuit 210 (e.g., the training circuit 210t) may be trained offline at an external high performance discrete AI GPU farm (e.g., remotely from the machine 100 as used in the field). Based on the training, the training circuit 210t may generate a trained ML model 212. In some embodiments, the trained ML model 212 may be stored in the system memory 270.

In some embodiments, the ML model 212 may be trained based on two sets of graphics processing circuits 240 (e.g., two sets of AI GPUs) to generate two models with the same input set for duplication redundancy of about 99.999% (e.g., to meet an ASIL D quality level). For example, the training circuit 210t may include a first training ML model 212ta and a second training ML model 212tb. In some embodiments, two ML models 212ta and 212tb are independently generated from two independent training circuits. In other words, the first training ML model 212ta may be generated from a first training circuit, and the second training ML model 212tb may be generated from a second training circuit (independent of the first training ML model 212ta and the first training circuit). The first training ML model 212ta and the second training ML model 212tb may be trained based on the outputs of the two sets of GPUs. The two sets of GPUs may be provided with the same input data set (e.g., the same given pre-determined 3D object set). In such embodiments, the training checking circuit 220t may receive outputs from the training circuit 210t and may determine whether the outputs from the two ML models 212ta and 212tb match. If the outputs do not match (e.g., if a mismatch, a difference, and/or a timeout is detected), the training checking circuit 220t may output the error signal ES indicating a problem with the GPUs and prompting a re-training of the two ML models 212ta and 212tb. If, on the other hand, the outputs match, the training checking circuit 220t may send the trained ML model 212 to the system memory 270 based on either of the two ML models 212ta or 212tb.

In some embodiments, after the training finishes, then the trained ML model 212 may be used in mission-mode checking, as discussed above, to perform end-to-end checking to determine whether the trained ML model 212 passes all checking 100% from end to end (e.g., from an output of the checking circuit 220 to an input of the checking circuit 220). After the end-to-end checking is finished, the trained ML model 212 may be ready for use in the field (e.g., in the machine 100) for the given pre-determined 3D object set. The training process may be repeated when a new pre-determined 3D object is added or exchanged in the previous pre-determined 3D object set.

FIG. 3 is a block diagram depicting an online updating and training flow for the system of FIG. 1, according to some embodiments of the present disclosure.

In some embodiments, online updating and training may be performed when the machine 100 is parked and may be exited before entering (e.g., before re-entering) the mission-mode checking flow. The ability to train the ML model 212 to be a high-quality model may depend on a number of operations per second (e.g., trillion operations per second (TOPS)), memory size, and bandwidth capabilities. For example, smaller incremental updates to 3D objects in the data set may allow for easier updating of the ML model 212 than larger updates. Greater TOPS, memory size, and/or bandwidth capabilities may allow for easier updating of the ML model 212 than smaller TOPS, memory size, and/or bandwidth capabilities. In some embodiments, the device 200 may receive an update, which may be executed via online training to update the trained ML model 212. For example, the updating may include changing weights of the ML model 212 and the training may include adding new objects to the data set and training the ML model 212 to recognize the new objects. In some embodiments, the trained ML model 212 (for example an updated version of the ML model 212) may be stored in the system memory 270. In some embodiments, the update can be received wirelessly (also referred to as an “over-the-air (OTA) update”). For example, the device 200 may receive the OTA update when the machine 100 (e.g., a car) is stationary (e.g., parked). In some embodiments, both updating and training are performed online.

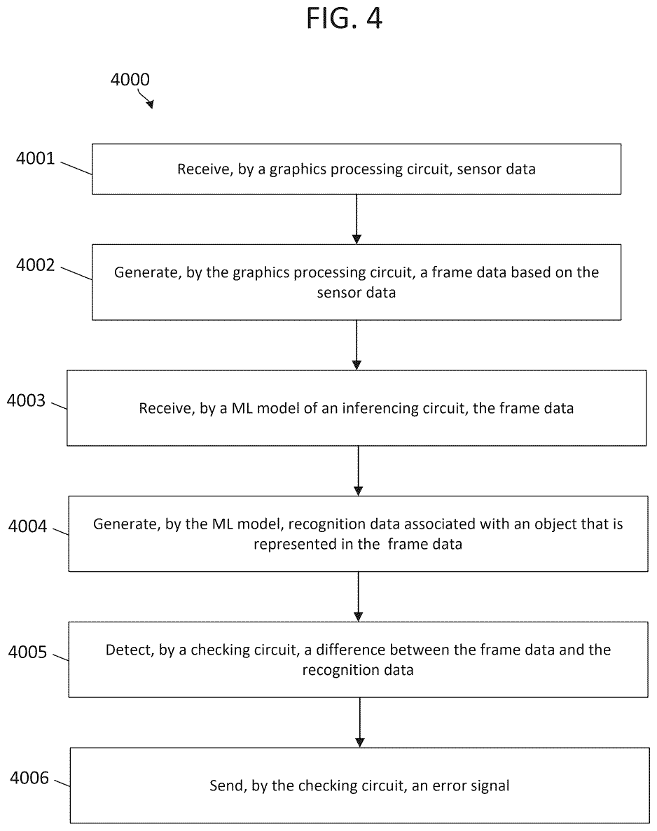

FIG. 4 is a flowchart depicting example operations of a method 4000 for detecting errors in frame data using AI, according to some embodiments of the present disclosure.

Referring to FIG. 4, the method 4000 may include one or more of the following operations. The graphics processing circuit 240 may receive sensor data SD (operation 4001). The graphics processing circuit 240 may generate frame data FD based on the sensor data SD (operation 4002). The ML model 212 of the inferencing circuit 210 (e.g., an NPU) may receive frame data FD (operation 4003). The ML model 212 may generate recognition data RD associated with an object that is represented in the second frame data (operation 4004). For example, the object may include safety-related information such as the speed of a vehicle as measured by a sensor that generated the sensor data SD. Once the checking circuit 220 (e.g., a CPU) detects a difference (e.g., a mismatch) between the sensor data (e.g., the sensed speed of the vehicle) and the recognition data (e.g., the speed of the vehicle inferred from the frame data FD) (operation 4005), the checking circuit 220 may send the error signal ES based on detecting the difference between the sensor data and the recognition data (e.g., based on detecting an error) (operation 4006). For example, the checking circuit 220 may send the error signal ES to a fault handling circuit 260 for performing a corrective action or for performing a danger-mitigation action (e.g., a safety precaution). For example, the fault handling circuit may notify a user of the occurrence of the error.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving, by a graphics processing circuit, sensor data;
generating, by the graphics processing circuit, first frame data based on the sensor data;
receiving, by a machine-learning model of an inferencing circuit, second frame data generated based on the first frame data;
generating, by the machine-learning model, recognition data associated with the second frame data;
detecting, by a checking circuit, a difference between the sensor data and the recognition data; and
sending, by the checking circuit, an error signal.

2. The method of claim 1, wherein:
the detecting the difference between the sensor data and the recognition data comprises determining that an object is erroneously represented in the first frame data.

3. The method of claim 1, wherein:
the inferencing circuit comprises a neural processing unit (NPU);
the checking circuit comprises a central processing unit (CPU); and
the NPU and the CPU comply with a standardized automotive safety level.

4. The method of claim 1, wherein at least one of the graphics processing circuit, the inferencing circuit, or the checking circuit comprises multiple instances.

5. The method of claim 1, further comprising:
receiving, by a fault handling circuit, the error signal;
generating, by the fault handling circuit, an interrupt to reset the graphics processing circuit; and
sending, by the fault handling circuit, a report to a microcontroller.

6. The method of claim 1, further comprising:
training the machine-learning model offline based on training frame data generated by a training graphics processing circuit, the training comprising:
receiving, by a first training machine-learning model, the training frame data;
receiving, by a second training machine-learning model, the training frame data; and
determining that a first output of the first training machine-learning model matches a second output of the second training machine-learning model.

7. The method of claim 1, further comprising:
receiving an update to the machine-learning model;
generating an updated machine-learning model based on the update; and
training the updated machine-learning model online.

8. The method of claim 7, wherein the receiving of the update to the machine-learning model is performed wirelessly.

9. The method of claim 1, wherein the sensor data is associated with operating a vehicle or operating a robot.

10. A system comprising:
a graphics processing circuit configured to receive sensor data and generate first frame data based on the sensor data;
an inferencing circuit comprising a machine-learning model configured to:
receive second frame data generated based on the first frame data; and
generate recognition data associated with the second frame data; and
a checking circuit configured to:
detect a difference between the sensor data and the recognition data; and
send an error signal.

11. The system of claim 10, wherein the detecting the difference between the sensor data and the recognition data comprises determining that an object is erroneously represented in the first frame data.

12. The system of claim 11, wherein:
the inferencing circuit comprises a neural processing unit (NPU);
the checking circuit comprises a central processing unit (CPU); and
the NPU and the CPU comply with a standardized automotive safety level.

13. The system of claim 10, further comprising a compression circuit configured to compress the first frame data to generate the second frame data.

14. The system of claim 10, further comprising a fault handling circuit configured to perform:
receiving the error signal;
generating an interrupt to reset the graphics processing circuit; and
sending a report to a microcontroller.

15. The system of claim 10, wherein the machine-learning model is trained offline based on training frame data generated by a training graphics processing circuit, the training comprising:
receiving, by a first training machine-learning model, the training frame data;
receiving, by a second training machine-learning model, the training frame data; and
determining that a first output of the first training machine-learning model matches a second output of the second training machine-learning model.

16. The system of claim 10, configured to perform:
receiving an update to the machine-learning model;
generating an updated machine-learning model based on the update; and
training the updated machine-learning model online.

17. The system of claim 16, wherein the receiving of the update to the machine-learning model is performed wirelessly.

18. A system comprising:
a processing circuit; and
a memory communicatively coupled to the processing circuit and storing instructions that, based on being executed by the processing circuit, cause the processing circuit to:
receive sensor data;
receive recognition data from an inferencing circuit, the recognition data being generated based on first frame data from a graphics processing circuit;
detect a difference between the sensor data and the recognition data; and
send an error signal.

19. The system of claim 18, wherein the detecting the difference between the sensor data and the recognition data comprises determining that an object is erroneously represented in the first frame data.

20. The system of claim 18, wherein the system is a vehicle or a robot.
